(19) United States
(12) Patent Application Publication
(10) Pub. No.: US 2026/0112217 A1
(43) Pub. Date: Apr. 23, 2026

(54) METHOD FOR DETECTING AN ANOMALY IN A DEVICE OF INTEREST BELONGING TO A FLEET OF DEVICES

(71) Applicant: Schaeffler Technologies AG & Co. KG, Herzogenaurach (DE)

(72) Inventors: Camille DENERT, Toulouse (FR); Clara MURILLO, Toulouse (FR); Nicolas LAMARQUE, Toulouse (FR)

(21) Appl. No.: 19/166,431

(22) PCT Filed: May 13, 2024
(86) PCT No.: PCT/EP2024/063018

§ 371 Date: Sep. 17, 2025

(30) Foreign Application Priority Data
May 16, 2023 (FR) 2304834

(51) Int. Cl. G07C 5/08; G07C 5/00

(52) U.S. Cl. CPC G07C 5/0808; G07C 5/008

(57) ABSTRACT

A method for detecting an anomaly in a device of interest belonging to a fleet of devices, includes: acquiring a new dataset, with each data item representing the value of a respective quantity of the device of interest; updating a main database, for adding the new dataset thereto; weighting the datasets of the main database; extracting, from the main database, a reference database consolidating datasets associated with devices of the fleet of devices, excluding datasets associated with the device of interest; extracting, from the main database, an analysis database consolidating datasets associated with the device of interest; comparing, for at least one quantity, corresponding data of the analysis and reference databases; and detecting an anomaly in the device of interest, when, for at least one of the quantities, the corresponding data of the analysis database deviates beyond a predetermined threshold relative to the corresponding data of the reference database.

### TECHNICAL FIELD OF THE INVENTION

One aspect of the invention relates to a method for detecting an anomaly in a device of interest belonging to a fleet of devices. The invention is particularly advantageously applicable in the field of motor vehicles, but can be applied to other devices, such as high-pressure cleaning devices or any other device provided with an electrical system.

### TECHNOLOGICAL BACKGROUND OF THE INVENTION

Motor vehicles that are intended to be produced are usually trialed and validated during fleet driving phases carried out before series production begins. The data of a fleet of vehicles is stored and is available to professional teams for validation. In order to know whether a component of a motor vehicle is defective or if a behavior is abnormal, the data is generally compared with thresholds. The acceptance limits are empirically set based on professional experience and knowledge. Another method involves computing diagnostics in computers on board the vehicles as a function of thresholds or sequences of events.

These methods allow an anomaly in the operation of a vehicle to be detected by comparing it to previously determined thresholds. These methods nevertheless can be improved.

### SUMMARY OF THE INVENTION

The aim of the invention is to overcome the disadvantages of the prior art by proposing a method for detecting an anomaly in a device of interest belonging to a fleet of devices that provides more precise detection.

Within this context, the invention thus relates, in its broadest sense, to a method for detecting an anomaly in a device of interest belonging to a fleet of devices, the method comprising the following steps, executed by an anomaly detection system, of:
acquiring a new dataset, in which each data item represents the value of a respective quantity relating to said device of interest;
updating a database, called main database, for adding said new acquired dataset thereto in conjunction with information relating to at least one descriptive feature of said device of interest at the acquisition time of said new data set;
extracting, from said main database, a database, called reference database, with the reference database consolidating datasets associated with devices of said fleet of devices having said at least one descriptive feature, excluding datasets associated with the device of interest;
extracting, from the main database, a database, called analysis database, consolidating datasets associated with said device of interest and said at least one descriptive feature;
comparing, for at least one quantity and by means of a statistical analysis, the corresponding data of the analysis database and corresponding data of the reference database; (in other words, the data in the analysis database associated with said quantity and the data in the reference database associated with this same quantity);
detecting an anomaly in said device of interest, when, for at least one of the quantities, the corresponding data of the analysis database deviates beyond a predetermined threshold relative to the corresponding data of the reference database.

By virtue of the invention, it is possible to determine whether a device belonging to a fleet of vehicles is atypical, based on the behavior of the other vehicles with the same descriptive feature. In other words, the data of a device of interest is not simply compared with thresholds, but is compared with the data of similar devices in order to determine whether the device of interest exhibits an anomaly. Advantageously, the devices are motor vehicles.

In addition to the features set forth in the previous paragraph, the method according to this aspect of the invention can have one or more additional features from among the following features, considered individually or according to all technically feasible combinations.

According to a non-limiting aspect of the invention, the method comprises a preliminary step of constructing the main database, with this preliminary step involving consolidating a plurality of sets of collected data, said datasets having been determined by the devices of the fleet of devices, each data item representing the value of a respective quantity relating to a device of said fleet of devices, each dataset of a device of the fleet of devices being associated with at least one descriptive feature of said device at the acquisition time of said dataset.

According to a non-limiting aspect of the invention, at least one of the data items from among the data of the new acquired dataset is measured by an on-board sensor on the device of interest, or is computed, by an on-board computer on the device of interest, from at least two data items acquired by two sensors on board said device of interest.

According to a non-limiting aspect of the invention, the quantities associated with the new acquired dataset are mutually decorrelated.

According to a non-limiting aspect of the invention, the at least one descriptive feature of the device of interest at the acquisition time of the new dataset comprises the model of the device of interest, with the reference database consolidating datasets only associated with devices of this same model.

According to a non-limiting aspect of the invention, the at least one descriptive feature of the device of interest at the acquisition time of the new dataset further comprises a version of software for controlling functionalities of the device of interest, installed on a computer of the device of interest at said acquisition time, with the reference and analysis databases consolidating datasets only associated with devices of this same model and in which the same version of the software is installed.

According to a non-limiting aspect of the invention, the at least one descriptive feature of the device of interest at the acquisition time of the new dataset further comprises an operating state of the device of interest at said acquisition time, with the reference and analysis databases consolidating datasets only associated with devices at least having the same model and said operating state.

According to a non-limiting aspect of the invention, the reference and analysis databases consolidate datasets associated with acquisition times within a time interval with a predetermined duration and prior to the acquisition time of the new dataset, and/or datasets associated with a maximum distance traveled by the device of interest up until the acquisition time of the new dataset.

According to one aspect of the invention, the method comprises a step of weighting the datasets.

According to a non-limiting aspect of the invention, the new dataset, acquired by the anomaly detection system, directly originates from means for transmitting new datasets included in the device of interest.

According to a non-limiting aspect of the invention, the fleet of devices is formed by a fleet of motor vehicles and the device of interest is formed by a motor vehicle of interest.

Another aspect of the invention relates to a computer program product comprising instructions which, when the program is executed by the anomaly detection system, cause it to implement the steps of the method according to any one of the aforementioned aspects.

The invention and the various applications thereof will be better understood upon reading the following description and with reference to the accompanying figure.

### BRIEF DESCRIPTION OF THE FIGURES

The FIGURE is provided by way of a non-limiting indication of the invention.

FIG. 1 schematically illustrates an anomaly detection system configured to execute the steps of a method for detecting an anomaly in a device of interest according to a non-limiting aspect of the invention.

### DETAILED DESCRIPTION

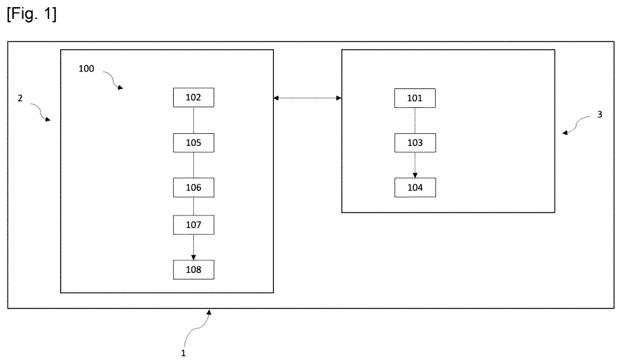

As illustrated in FIG. 1, the anomaly detection system 1 comprises anomaly detection means 2 arranged to communicate with consolidating means 3, and a method 100 implemented within said anomaly detection system 1.

The anomaly detection means 2 comprise at least one processor and at least one memory. They can be formed by one or more computers and/or one or more servers and/or one or more virtual machines.

These detection means 2 are configured to execute steps of the anomaly detection method 100 on a device of interest belonging to a fleet of devices.

Similarly, the consolidating means 3 comprise at least one processor and at least one memory. They can be formed by one or more computers and/or one or more servers and/or one or more virtual machines.

These consolidating means 3 are configured to execute a preliminary step of constructing a database, called main database, a step of updating the main database and a step of weighting certain data in the main database.

In the non-limiting example of the description, the devices are formed by motor vehicles. In variants, the devices can be machine tools, or cleaning appliances, etc.

The method 100 in this case comprises a preliminary step 101, executed by the consolidating means 3, of constructing a main database, involving consolidating a plurality of sets of collected data where each data item represents the value of a respective quantity of a vehicle of the fleet of vehicles. In a non-limiting manner, the data can relate to the engine of the vehicle, to a consumption of the vehicle or even to a braking system of the vehicle. This preliminary step 101 is implemented only once, and is not subsequently repeated so that the invention is not limited to a method comprising this preliminary step 101.

Each data item of a dataset representing the value of a respective quantity of a vehicle can be measured by a sensor on board the vehicle, or can be computed based on at least two data items acquired by two sensors on board the vehicle. In the invention, the various datasets all relate to the same set of quantities.

It should be noted that the quantities of the various datasets are mutually decorrelated. For example, the vehicles do not travel on the same day and/or in different geographical areas and/or under different operating conditions. Preferably, at least some of the quantities of the same vehicle are also decorrelated, in that they do not relate to the same physical parameter of the same element of the vehicle.

The datasets can be directly transmitted to the consolidating means 3 by means for transmitting new datasets included in the vehicles.

In a different embodiment, the datasets are downloaded when checking a vehicle of the fleet in a service center for the vehicle, then transmitted from the service center to the consolidating means 3.

Furthermore, it should be noted that each dataset of a vehicle of the fleet of vehicles is associated with at least one descriptive feature of the vehicle at the acquisition time of the dataset.

The descriptive feature of the vehicle can be formed by the vehicle model, with the term “model” being understood in terms of its sense of “category”, with the vehicles of the same model having predetermined common features. The model of the vehicle can be designated by an identification number of the vehicle, better known as the VIN (Vehicle Identification Number).

Optionally, the at least one descriptive feature of the vehicle can also comprise a version of software for controlling functionalities of the vehicle, installed on a computer of the vehicle.

Additionally or as a variant, the at least one descriptive feature of the vehicle can further comprise an operating state of the vehicle.

In a non-limiting manner, this operating state can be formed by a range of engine speeds or even a range of temperatures outside the vehicle. Indeed, different operating states can sometimes explain specific drifts or wear of certain components.

During use after the main database has been constructed, the method 100 comprises a step 102, executed by the anomaly detection means 2, of acquiring a new dataset, in which each data item represents the value of a respective quantity relating to the vehicle of interest. The vehicle of interest belongs to a fleet of vehicles, distinct or similar to the fleet of vehicles used in the preliminary step 101 of constructing the main database. The new dataset can be transmitted directly to the anomaly detection means 2, for example, by transmission means in the vehicle of interest.

The datasets can be transmitted to the anomaly detection means 2 in real time, for example, at a regular frequency in terms of mileage and/or duration of use. As a variant, the datasets can be temporarily stored within the vehicle (for example, at a regular frequency in terms of mileage and/or duration of use), before being transmitted in packets to the anomaly detection means 2, when checking the vehicle in a service center for the vehicle.

The datasets can therefore travel directly from the vehicle to the anomaly detection means 2, via a wireless communication. As a variant, the datasets can initially travel from the vehicle to a central computer, for example, via a wired communication, then from the central computer to the anomaly detection means 2, via a wireless communication. Preferably, the dataset of step 102 relates to the same data as the dataset of step 101, with only the values assumed by the latter being optionally modified.

At least one of the data items from among the data of the new acquired dataset is measured by an on-board sensor on the device of interest, or is computed, by an on-board computer on said device of interest, from at least two data items acquired by two sensors on board the device of interest.

The method 100 then comprises a step 103, executed by the consolidating means 3, of updating the main database, in order to add the new acquired dataset thereto, in conjunction with information relating to at least one descriptive feature of the vehicle of interest at the acquisition time 102 of the new dataset. Advantageously, the descriptive feature is transmitted to the anomaly detection means 2 at the same time as the dataset acquired in step 102.

Optionally, the at least one descriptive feature of the vehicle of interest at the acquisition time of the new dataset comprises the model of the vehicle of interest, for example, the identification number of the vehicle of interest.

In a further different embodiment, the at least one descriptive feature of the vehicle of interest at the acquisition time of the new dataset comprises the model of the vehicle of interest and a version of software for controlling functionalities of the vehicle of interest installed on a computer of the vehicle of interest.

In an optional embodiment, the at least one descriptive feature of the vehicle of interest at the acquisition time of the new dataset comprises the model of the vehicle of interest and an operating state of the vehicle of interest, and optionally a version of software for controlling functionalities of the vehicle of interest installed on a computer of the vehicle of interest.

Optionally, the method 100 can comprise a step 104, executed by the consolidating means 3, of weighting the datasets. For example, in order to avoid distorting the results, a lower weight can be assigned to the data of a vehicle with high mileage (thus providing data more frequently than the other vehicles), compared to the other vehicles of the fleet of vehicles.

From the main database, the method 100 comprises a step 105, executed by the anomaly detection means 2, of extracting a database, called reference database, with the reference database consolidating datasets associated with vehicles of the fleet of vehicles having said at least one descriptive feature, and the reference database excluding the datasets associated with the vehicle of interest. The exclusion of the datasets associated with the vehicle of interest is an original feature and prevents the subsequent analysis from being distorted, in the event that the vehicle of interest exhibits an anomaly.

In one embodiment, and in a non-limiting manner, the reference database can consolidate datasets associated with acquisition times within a time interval with a predetermined duration, prior to the acquisition time of the new dataset. This predetermined duration can be one month, for example. Preferably, the considered time interval is immediately before the acquisition time of the new dataset.

This time interval by construction allows the amount of data to be processed to be reduced and consequently allows the data processing time to be reduced. Furthermore, it allows less relevant data to be gradually dispensed with that relates, for example, to old versions of at least one data processing and acquisition software application installed on a computer of the vehicle. This also means that if an anomaly appears at a specific point in time, it will be clearly visible in the data set and will not be buried among older data that does not exhibit the anomaly.

As a variant, the reference database consolidates datasets associated with a maximum distance traveled by the device of interest up until the acquisition time of the new dataset. Preferably, the considered maximum distance is immediately before the acquisition time of the new dataset.

Thus, the datasets of the reference database can be associated with a vehicle model, optionally with a software version and/or with an operating state, and can be limited to a time interval with a predetermined duration or a maximum traveled distance.

Then, based on the main database, the method 100 comprises a step 106, executed by the anomaly detection means 2, of extracting a database, called analysis database, consolidating datasets associated with the device of interest and with the at least one descriptive feature.

Thus, the datasets of the analysis database can be associated with a vehicle model, optionally with a software version and/or with an operating state, and can be limited to a time interval with a predetermined duration or a maximum traveled distance.

For at least one quantity of the datasets, the method 100 comprises a step 107, executed by the anomaly detection means 2, of comparing, by means of a statistical analysis, the corresponding data of the analysis database and the corresponding data of the reference database. Preferably, each quantity undergoes said statistical analysis. As a variant, a portion of the quantities is considered to be irrelevant, given, for example, information relating to a current operating state of the vehicle of interest.

According to an optional embodiment, if the amount of data relating to a specific quantity in the datasets is not large enough, the statistical analysis on said specific quantity is not taken into account because it is considered to be statistically invalid.

In a non-limiting manner, this statistical analysis can be formed by a Quantile-Quantile type analysis (also called Q-Q plot).

In a different embodiment, the statistical analysis can be formed by a Kolmogorov-Smirnov type analysis.

In any case, the statistical analysis allows abnormal values to be identified, without a priori knowledge concerning the expected values. The reference population, formed by the data of the reference database, is not fixed. On the contrary, it is updated as the vehicle fleet is used, in order to provide the most relevant anomaly detection possible.

The method 100 further comprises a step 108, executed by the anomaly detection means 2, of detecting an anomaly in the vehicle of interest, when, for at least one of the quantities compared by means of a statistical analysis, the corresponding data of the analysis database deviates beyond a predetermined threshold relative to the corresponding data of the reference database. The predetermined threshold is advantageously computed in a preliminary step. It can be based on a priori knowledge relating to acceptable margins of error, notably when the quantity follows a known probability law such as a Gaussian law. As a variant, the predetermined threshold can be based on feedback.

Thus, the data of the vehicle of interest is compared with similar vehicle data in order to determine whether the vehicle of interest exhibits an anomaly. In other words, the behavior of the other vehicles is used as a basis for determining whether the vehicle of interest has an anomaly.

The centralization of the data by the consolidating means 3 allows computations to be carried out on large-scale data with virtual machines whose size allows daily and automated processing of this data. The automation and daily processing of the data allows anomaly detection to be improved and also allows anomalies to be detected that occur over time. Thus, when this method is implemented on production vehicles, anomalies can be detected as the vehicle is used. When an anomaly is detected, the driver can be warned so that they can take their vehicle to a service center so that it can be checked and/or repaired.

Optionally, the method further comprises a step, not shown, of issuing a warning message from the anomaly detection means 2 to the vehicle of interest, or to a computer of a control center, when an anomaly is detected on said vehicle of interest.

1. A method for detecting an anomaly in a device of interest belonging to a fleet of devices, said method comprising the following steps, executed by an anomaly detection system, of:
acquiring a new dataset, in which each data item represents the value of a respective quantity relating to said device of interest;
updating a database, called main database, for adding said new acquired dataset thereto in conjunction with information relating to at least one descriptive feature of said device of interest at the acquisition time of said new data set;
weighting the datasets of the main database, so as to assign a lower weight to the data of a device providing data more frequently than the others;
extracting, from said main database, a database, called reference database, with said reference database consolidating datasets associated with devices of said fleet of devices having said at least one descriptive feature, excluding datasets associated with said device of interest;
extracting, from said main database, a database, called analysis database, consolidating datasets associated with said device of interest and said at least one descriptive feature;
comparing, for at least one quantity and by means of a statistical analysis, the corresponding data of said analysis database and corresponding data of said reference database;
detecting an anomaly in said device of interest, when, for at least one of said quantities, the corresponding data of said analysis database deviates beyond a predetermined threshold relative to the corresponding data of said reference database.

2. The method as claimed in claim 1, further comprising a preliminary step of constructing the main database, with this preliminary step involving consolidating a plurality of sets of collected data, said datasets having been determined by the devices of the fleet of devices, each data item representing the value of a respective quantity relative to a device of said fleet of devices, each dataset of a device of the fleet of devices being associated with at least one descriptive feature of said device at the acquisition time of said dataset.

3. The method as claimed in claim 1, wherein at least one of the data items from among the data of the new acquired dataset is measured by an on-board sensor on the device of interest, or is computed, by an on-board computer on said device of interest, from at least two data items acquired by two sensors on board said device of interest.

4. The method as claimed in claim 1, wherein the quantities associated with the new acquired dataset are mutually decorrelated.

5. The method as claimed in claim 1, wherein the at least one descriptive feature of the device of interest at the acquisition time of the new dataset comprises the model of said device of interest, with the reference database consolidating datasets only associated with devices of this same model.

6. The method as claimed in claim 5, wherein the at least one descriptive feature of the device of interest at the acquisition time of the new dataset further comprises a version of software for controlling functionalities of the device of interest, installed on a computer of the device of interest at said acquisition time, with the reference and analysis databases consolidating datasets only associated with devices of this same model and in which the same version of the software is installed.

7. The method as claimed in claim 5, wherein the at least one descriptive feature of the device of interest at the acquisition time of the new dataset further comprises an operating state of the device of interest at said acquisition time, with the reference and analysis databases consolidating datasets only associated with devices at least having the same model and said operating state.

8. The method as claimed in claim 1, wherein the reference and analysis databases consolidate datasets associated with acquisition times within a time interval with a predetermined duration and prior to the acquisition time of the new dataset, and/or datasets associated with a maximum distance traveled by the device of interest up until the acquisition time of the new dataset.

9. The method as claimed in claim 1, wherein the new dataset, acquired by the anomaly detection system, directly originates from means for transmitting new datasets included in the device of interest.

10. The method as claimed in claim 1, wherein the fleet of devices is formed by a fleet of motor vehicles and the device of interest is formed by a motor vehicle of interest.

11. A computer program product comprising instructions which, when the program is executed by the anomaly detection system, cause it to implement the steps of the method as claimed in claim 1.

12. The method as claimed in claim 2, wherein at least one of the data items from among the data of the new acquired dataset is measured by an on-board sensor on the device of interest, or is computed, by an on-board computer on said device of interest, from at least two data items acquired by two sensors on board said device of interest.

13. The method as claimed in claim 2, wherein the quantities associated with the new acquired dataset are mutually decorrelated.

14. The method as claimed in claim 3, wherein the quantities associated with the new acquired dataset are mutually decorrelated.

15. The method as claimed in claim 2, wherein the at least one descriptive feature of the device of interest at the acquisition time of the new dataset comprises the model of said device of interest, with the reference database consolidating datasets only associated with devices of this same model.

16. The method as claimed in claim 3, wherein the at least one descriptive feature of the device of interest at the acquisition time of the new dataset comprises the model of said device of interest, with the reference database consolidating datasets only associated with devices of this same model.

17. The method as claimed in claim 4, wherein the at least one descriptive feature of the device of interest at the acquisition time of the new dataset comprises the model of said device of interest, with the reference database consolidating datasets only associated with devices of this same model.

18. The method as claimed in claim 6, wherein the at least one descriptive feature of the device of interest at the acquisition time of the new dataset further comprises an operating state of the device of interest at said acquisition time, with the reference and analysis databases consolidating datasets only associated with devices at least having the same model and said operating state.

19. The method as claimed in claim 2, wherein the reference and analysis databases consolidate datasets associated with acquisition times within a time interval with a predetermined duration and prior to the acquisition time of the new dataset, and/or datasets associated with a maximum distance traveled by the device of interest up until the acquisition time of the new dataset.

20. The method as claimed in claim 3, wherein the reference and analysis databases consolidate datasets associated with acquisition times within a time interval with a predetermined duration and prior to the acquisition time of the new dataset, and/or datasets associated with a maximum distance traveled by the device of interest up until the acquisition time of the new dataset.
